(19) United States
(12) Patent Application Publication
(10) Pub. No.: US 2022/0237579 A1
(43) Pub. Date: Jul. 28, 2022

(54) COMMODITY RECOGNITION SYSTEM, METHOD, AND NON-TRANSITORY COMPUTER READABLE MEDIUM

(71) Applicant: NEC Platforms, Ltd., Kawasaki-shi (JP)

(72) Inventor: Shuhei ITOH, Kanagawa (JP)

(73) Assignee: NEC Platforms, Ltd., Kawasaki-shi (JP)

(21) Appl. No.: 17/575,853

(22) Filed: Jan. 14, 2022

(30) Foreign Application Priority Data
Jan. 26, 2021 (JP) 2021-010438

(51) Int. Cl. G06Q 20/18; G06N 5/04

(52) U.S. Cl. CPC G06Q 20/18; G06N 5/04

(57) ABSTRACT

A commodity recognition system, a method, and a non-transitory computer readable medium capable of reducing a possibility that a payment is carried out without recognizing mis-recognition of a commodity are provided. The commodity recognition system according to the present disclosure includes an image acquisition unit, an inference unit, and a display unit. The image acquisition unit acquires an image of an article including a payment article when a user makes a payment. The inference unit identifies the article included in the image, and infers whether the identified article is a payment article or a non-payment article by referring to identification information of an article and information indicating whether the article is the payment article or not, both of which are associated with each other and stored in advance. The display unit displays the payment article and the non-payment article for the user while distinguishing them from each other.

### INCORPORATION BY REFERENCE

This application is based upon and claims the benefit of priority from Japanese patent application No. 2021-010438, filed on Jan. 26, 2021, the disclosure of which is incorporated herein in its entirety by reference.

### TECHNICAL FIELD

The present disclosure relates to a commodity recognition system, a method, and a non-transitory computer readable medium.

### BACKGROUND ART

A variety of POS (Point-of-Sales) systems that carry out a payment for commodities through image recognition have been proposed. For example, Japanese Unexamined Patent Application Publication No. 2015-038719 discloses a POS system in which recognition means recognizes, based on an image of a commodity taken by image pickup means, a candidate commodity for the commodity, and the candidate commodity recognized by the recognition means is displayed.

However, in the POS system according to the background art, there are cases where, in the image recognition, a non-payment article that is provided to a user free of charge may be mis-recognized, i.e., incorrectly recognized, as a payment article that is provided to a user for a fee. FIG. 9 shows an example in which water is mis-recognized as miso soup in image recognition. In this case, although water is not a payment article, the user is charged an additional fee for miso soup. That is, the user is charged an extra fee, i.e., an unnecessary fee. That is, the POS system according to the background art has a problem that a payment could be carried out without recognizing mis-recognition of a commodity.

### SUMMARY

In view of the above-described problem, an example object of the present disclosure is to provide a commodity recognition system, a method, and a non-transitory computer readable medium capable of reducing a possibility that a payment is carried out without recognizing mis-recognition of a commodity.

In a first example aspect, a commodity recognition system includes: an image acquisition unit configured to acquire an image of an article including a payment article when a user makes a payment; an inference unit configured to identify the article included in the image, and infer whether the identified article is the payment article or a non-payment article by referring to identification information of an article and information indicating whether the article is the payment article or not, the identification information and the information indicating whether the article is the payment article or not being associated with each other and stored in advance; and a display unit configured to display the payment article and the non-payment article for the user while distinguishing them from each other.

In another example aspect, a method includes: acquiring an image of an article including a payment article when a user makes a payment; identifying the article included in the image, and infer whether the identified article is the payment article or a non-payment article by referring to identification information of an article and information indicating whether the article is the payment article or not, the identification information and the information indicating whether the article is the payment article or not being associated with each other and stored in advance; and displaying the payment article and the non-payment article for the user while distinguishing them from each other.

In another example aspect, a non-transitory computer readable medium stores a program for causing a computer to perform: a process for acquiring an image of an article including a payment article when a user makes a payment; a process for identifying the article included in the image, and infer whether the identified article is the payment article or a non-payment article by referring to identification information of an article and information indicating whether the article is the payment article or not, the identification information and the information indicating whether the article is the payment article or not being associated with each other and stored in advance; and a process for displaying the payment article and the non-payment article for the user while distinguishing them from each other.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram showing a configuration of a commodity recognition system according to a first example embodiment;

FIG. 2 is a flowchart showing operations performed by the commodity recognition system according to the first example embodiment;

FIG. 3 is a schematic diagram showing a schematic configuration of a commodity recognition system according to a second example embodiment;

FIG. 4 is a block diagram showing a configuration of the commodity recognition system according to the second example embodiment;

FIG. 5 is a flowchart showing a learning operation performed by a commodity recognition apparatus according to the second example embodiment;

FIG. 6 is a schematic diagram showing a registration window in the commodity recognition apparatus according to the second example embodiment;

FIG. 7 is a flowchart showing an inference operation performed by the commodity recognition apparatus according to the second example embodiment;

FIG. 8 is a schematic diagram showing an inference window in the commodity recognition apparatus according to the second example embodiment;

FIG. 9 is a schematic diagram showing an example of mis-recognition of a commodity in a commodity recognition system according to background art;

FIG. 10 is a block diagram showing a configuration of a commodity recognition system according to a third example embodiment; and

FIG. 11 is a block diagram showing a configuration of hardware according to an example embodiment.

### EXAMPLE EMBODIMENTS

Specific example embodiments to which the present disclosure is applied will be described hereinafter in detail with reference to the drawings. In the drawings, the same reference numerals are assigned to the same components, and redundant descriptions thereof are omitted as appropriate for clarifying the description.

### First Example Embodiment

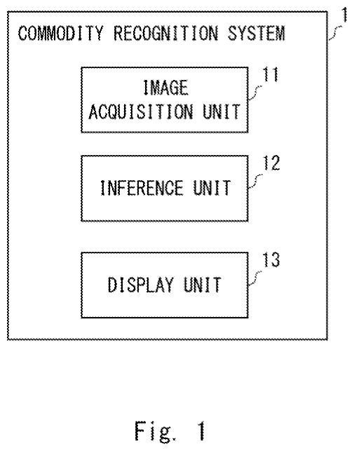

Firstly, a configuration of a commodity recognition system 1 according to a first example embodiment will be described with reference to FIG. 1. The commodity recognition system 1 includes an image acquisition unit 11, an inference unit 12, and a display unit 13. The image acquisition unit 11 acquires an image(s) of articles including a payment article(s), i.e., an article(s) for which a user has to pay the price thereof, when a user makes a payment. The inference unit 12 identifies an article included, i.e., shown, in the image, and infers whether the identified article is a payment article or a non-payment article, i.e., an article which is provided to a user free of charge, by referring to identification information of articles and information indicating whether the articles are payment articles or not, both of which, i.e., both the identification information and the information indicating whether the articles are payment articles or not, are associated with each other and stored in advance. The display unit 13 displays the payment article(s) and the non-payment article(s) for the user while distinguishing them from each other.

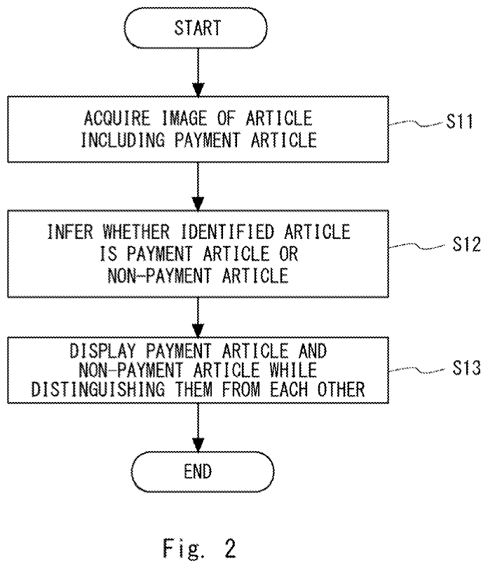

Next, operations performed by the commodity recognition system 1 according to the first example embodiment will be described with reference to FIG. 2.

Firstly, the image acquisition unit 11 acquires an image(s) of articles including a payment article(s) when a user makes a payment (Step S11). Next, the inference unit 12 identifies an article included in the image, and infers whether the identified article is a payment article or a non-payment article by referring to identification information of articles and information indicating whether the articles are payment articles or not, both of which are associated with each other and stored in advance (Step S12). Next, the display unit 13 displays the payment article(s) and the non-payment article(s) for the user while distinguishing them from each other (Step S13).

Therefore, in the commodity recognition system 1 according to the first example embodiment, the user can perceive whether or not a payment article has been mis-recognized as a non-payment article. Further, since the user can perceive, when such mis-recognition occurs in the commodity recognition system 1, that mis-recognition, he/she can correct the payment for the commodity. That is, the commodity recognition system 1 can reduce the possibility that a user makes a payment without noticing the mis-recognition of a commodity.

### Second Example Embodiment

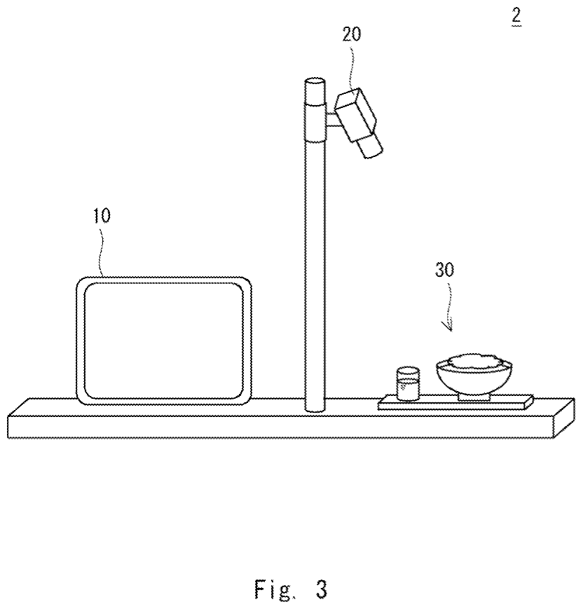

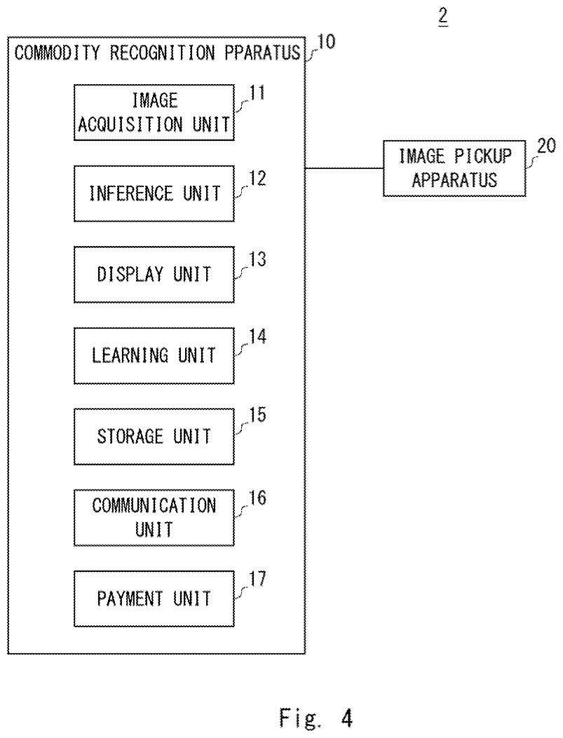

Next, a configuration of a commodity recognition system 2 according to a second example embodiment will be described with reference to FIGS. 3 and 4. The commodity recognition system 2 is a specific example of the commodity recognition system 1 according to the first example embodiment.

As shown in FIG. 3, the commodity recognition system 2 includes a commodity recognition apparatus 10 and an image pickup apparatus 20, and carries out a payment for a group of commodities 30 (hereinafter also referred to as a commodity group 30) by recognizing an image of the commodity group 30. The commodity recognition system 2 is installed, for example, in a cash register of a restaurant such as a company cafeteria, a self-service restaurant, or a franchise self-service noodle restaurant. This example embodiment will be described based on the assumption that the commodity recognition system 1 is installed in a cash register of a restaurant.

The image pickup apparatus 20 is, for example, an apparatus having an image pickup function, such as a camera, and takes an image of a commodity group 30 and transmits the taken image to the commodity recognition apparatus 10. The image pickup apparatus 20 takes an image of a commodity group 30 placed on a tray in the cash register from above it, and transmits the taken image including the commodity group 30 to the commodity recognition apparatus 10.

The commodity recognition apparatus 10 is, for example, a terminal such as a smartphone, a tablet-type computer, a PC (Personal Computer), or a cash register apparatus. Note that, in a narrow sense, the commodity recognition apparatus 10 constitutes the commodity recognition system 1 according to the first example embodiment. Specifically, as shown in FIG. 4, the commodity recognition apparatus 10 includes an image acquisition unit 11, an inference unit 12, a display unit 13, a learning unit 14, a storage unit 15, a communication unit 16, and a payment unit 17. Note that the commodity recognition apparatus 10 may also include an image pickup apparatus 20.

The image acquisition unit 11 acquires an image of articles (commodities) including a payment article(s) when a user makes a payment, and supplies the acquired image to the inference unit 12. Further, the image acquisition unit 11 acquires a taken image of articles (commodities) from the image pickup apparatus 20 and supplies the acquired taken image to the learning unit 14.

The inference unit 12 identifies an article included in the image, and infers whether the identified article is a payment article or a non-payment article by referring to identification information of articles and information indicating whether the articles are payment articles or not, both of which are associated with each other and stored in the storage unit 15 in advance. For example, the inference unit 12 identifies a commodity included in the image by using the outer shape of the commodity included in the image and the like as feature values, and infers a commodity name thereof. Then, the inference unit 12 infers information indicating whether the inferred commodity is a payment article or a non-payment article by referring to the inferred commodity name, and referring to information about commodity names of commodities and information indicating whether the commodities are payment articles or not, both of which are associated with each other and stored in advance in the storage unit 15. Then, the inference unit 12 supplies the inferred commodity name of the commodity and the information indicating whether the commodity is a payment article or a non-payment article to the display unit 13. Further, the inference unit 12 also infers information necessary for a payment, such as the price of the identified commodity, and supplies the inferred information to the payment unit 17.

Note that the non-payment article is an article that is provided to a user free of charge. In the case of Japanese cuisine, examples of the non-payment article include a glass of water (or tea), chopsticks, a small plate, and a spoon. In the case of Western cuisine, examples include a glass of water, a spoon, a fork, and a knife. Further, in the case of Chinese cuisine, examples include a glass of water (or tea), chopsticks, a small plate, and a china spoon. Meanwhile, the payment article is an article that is provided to a user for a fee. Examples of the payment article include dishes such as a chicken-and-egg bowl and Chinese noodle. Note that the payment article and the non-payment article are not limited to aforementioned articles, and various settings, i.e., definitions, can be made for them.

The display unit 13 displays the payment article(s) and the non-payment article(s) inferred by the inference unit 12 for the user by using a display device or the like while distinguishing them from each other. Specifically, the display unit 13 displays a window including the payment article(s) and the non-payment article(s), and distinguishes the payment article(s) and the non-payment article(s) from each other by displaying the non-payment article(s) in a more emphasized manner in the displayed window than the payment article(s). For example, the display unit 13 distinguishes the payment article(s) and the non-payment article(s) from each other by displaying an area corresponding to the non-payment article(s) in a shaded manner in the displayed window. Note that the way of distinguishing the payment article(s) and the non-payment article(s) from each other by the display unit 13 is not limited to the shading of the area corresponding to the non-payment article(s) in the displayed window. For example, the display unit 13 may emphasize the non-payment article(s) over the payment article(s) by changing the color or surrounding the area corresponding to the non-payment article(s) with a bold line.

The learning unit 14 acquires a taken image from the image acquisition unit 11, and stores, in the storage unit 15, an image of a commodity included in the acquired taken image, its commodity name, and information indicating whether the commodity is a payment article or a non-payment article while associating them with each other. The learning unit 14 acquires, for example, an image of water (a container containing water) from the image acquisition unit 11, and stores the image of the water in the storage unit 15 while associating it with a commodity name of water and information indicating that water is a non-payment article. Further, the learning unit 14 stores, in addition to the aforementioned information, information necessary for a payment such as the price while associating it with the image of the commodity included in the taken image.

The storage unit 15 stores images of commodities and commodity names thereof while associating them with each other. Further, the storage unit 15 stores commodity names of commodities and information indicating whether the commodities are payment articles or non-payment articles while associating them with each other. Further, in addition to the aforementioned information, the storage unit 15 stores information necessary for a payment such as the price while associating it with the commodity name of the commodity.

The communication unit 16 communicates with the image pickup apparatus 20 wirelessly or through a cable, and transmits/receives information to/from the image pickup apparatus 20.

The payment unit 17 carries out a payment for the commodity(ies) included in the taken image acquired by the image acquisition unit 11 based on the information supplied from the inference unit 12.

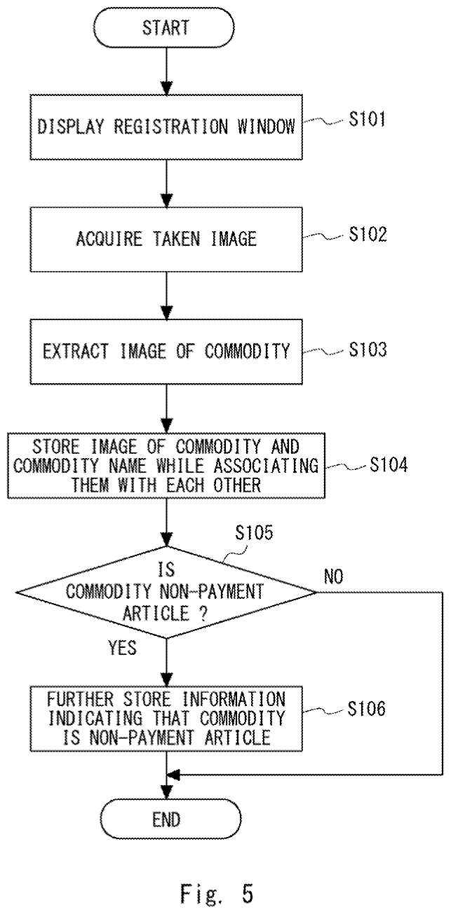

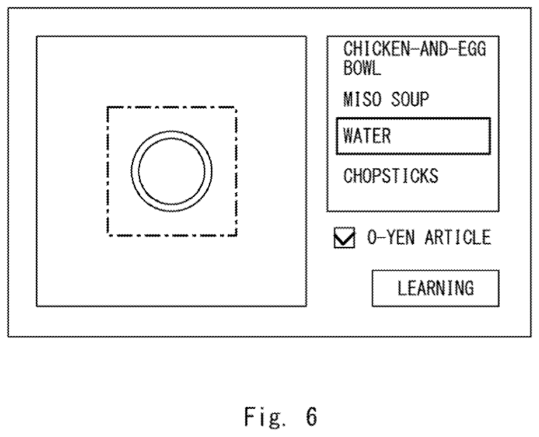

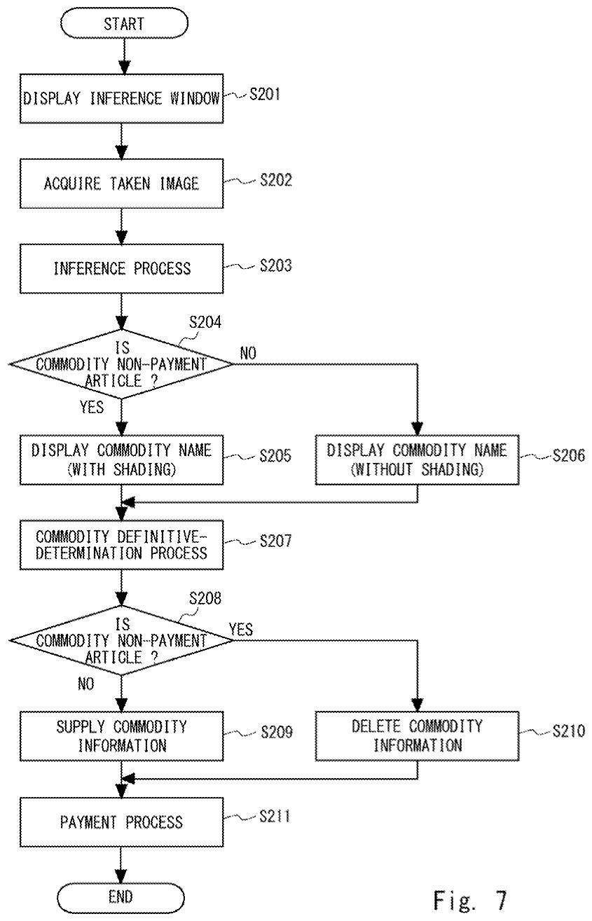

Next, operations performed by the commodity recognition apparatus 10 according to the second example embodiment will be described with reference to FIGS. 5 to 9. Specifically, the commodity recognition apparatus 10 performs a learning operation shown in FIGS. 5 and 6, and an inference operation for inferring a commodity based on learned information shown in FIGS. 7 to 9.

Firstly, the learning operation performed by the commodity recognition apparatus 10 according to the second example embodiment will be described with reference to FIG. 5.

As shown in FIG. 5, the display unit 13 of the commodity recognition apparatus 10 displays a registration window for registering a commodity on a display (Step S101). Then, a user takes an image of a commodity to be learned by using the image pickup apparatus 20 according to the registration window, i.e., instructions shown in the registration window, displayed on the commodity recognition apparatus 10. Then, the image pickup apparatus 20 transmits the taken image to the commodity recognition apparatus 10.

Next, the learning unit 14 of the commodity recognition apparatus 10 receives the taken image from the image pickup apparatus 20 through the communication unit 16 (Step S102). Then, the learning unit 14 extracts an image of the commodity (Step S103).

Next, the learning unit 14 associates the extracted image of the commodity with a commodity name (Step S104). Specifically, the display unit 13 displays the extracted image of the commodity on the registration window, and the user enters, in the registration window, a commodity name corresponding to the extracted commodity. In this process, the learning unit 14 stores the image of the commodity and the entered commodity name in the storage unit 15 while associating them with each other.

Further, the user determines whether the extracted commodity is a non-payment article or not based on information about the extracted image of the commodity displayed on the registration window. When the extracted commodity is a non-payment article (Yes in Step S105), the user enters, in the registration window, information indicating that the extracted commodity is a non-payment article. Then, the learning unit 14 stores the commodity name and the information indicating that the commodity is a non-payment article in the storage unit 15 while associating them with each other (Step S106). When the extracted commodity is not a non-payment article (No in Step S105), the commodity recognition apparatus 10 finishes the process.

FIG. 6 shows an example of the registration window that is displayed when a non-payment article is registered. As shown in FIG. 6, an image of a commodity, a candidate commodity name, and a checkbox through which the user selects whether the commodity is a non-payment article are displayed in the registration window. Note that, in the registration window, the user selects that the image of the commodity is water, i.e., selects water from among candidate commodity names including a chicken-and-egg bowl, miso soup, water, and chopsticks. Further, in the registration window, the user selects that the image of the commodity, i.e., water, is a non-payment article by ticking the checkbox indicating a non-payment article. When learning is performed in this state, the learning unit 14 stores, in the storage unit 15, information indicating that the image of the commodity is water and water is a non-payment article.

Note that, as shown in FIG. 5, when learning is performed again, the commodity recognition apparatus 10 may return to the process in the step S101, and store a commodity name and information indicating whether the commodity is a non-payment article or not in the storage unit 15 again while associating them with the image of the commodity.

Next, the inference operation performed by the commodity recognition apparatus 10 according to the second example embodiment will be described with reference to FIG. 7.

Firstly, the display unit 13 of the commodity recognition apparatus 10 displays, on the display, an inference window for inferring a commodity for which a user will make a payment (Step S201). Next, the user takes an image of a commodity to be inferred by using the image pickup apparatus 20 according to the inference window, i.e., instructions shown in the inference window, displayed on the commodity recognition apparatus 10. After that, the image pickup apparatus 20 transmits the taken image to the commodity recognition apparatus 10.

The inference unit 12 of the commodity recognition apparatus 10 acquires the taken image through the communication unit 16 (Step S202). Next, the inference unit 12 identifies an article included in the image and infers its commodity name. For example, the inference unit 12 identifies an article included in the image by using the outer shape of the commodity included in the image as feature values, and infers a commodity name thereof. Then, the inference unit 12 infers information indicating whether the identified commodity is a payment article or a non-payment article by referring to the inferred commodity name of the commodity, and referring to information about commodity names of commodities and information indicating whether the commodities are payment articles or not, both of which are associated with each other and stored in advance in the storage unit 15 (Step S203).

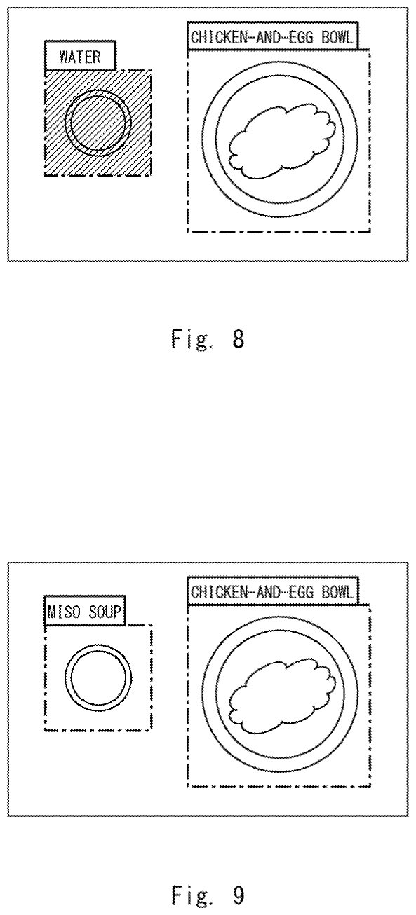

Next, when the commodity is a non-payment article (Yes in Step S204), the display unit 13 displays the commodity name in a shaded manner in the inference window (Step S205). Specifically, in the inference window shown in FIG. 8, the display unit 13 displays an image of “water”, and displays a commodity name “water” while attaching it to the image of “water”. Further, since the display unit 13 has inferred that the image of the “water” as a non-payment article, it displays the image of the “water” in a shaded manner.

On the other hand, as shown in FIG. 7, when the commodity is not a non-payment article (No in Step S204), the display unit 13 displays the commodity name without shading in the inference window (Step S206). Specifically, in the inference window shown in FIG. 8, the display unit 13 displays an image of a “chicken-and-egg bowl”, and displays a commodity name “chicken-and-egg bowl” while attaching it to the image of the “chicken-and-egg bowl”. Further, since the display unit 13 has not inferred that the image of the “chicken-and-egg bowl” as a non-payment article, it does not display the image of the “chicken-and-egg bowl” in a shaded manner, i.e., displays it without shading.

Note that the user can determine, by referring to the displayed inference window, whether the commodity he/she is purchasing has been correctly recognized by the commodity recognition apparatus 10, i.e., whether a non-payment article is not mis-recognized as a different payment article. By doing so, the user can correct the payment when he/she makes a payment as described later.

Next, as shown in FIG. 7, the inference unit 12 of the commodity recognition apparatus 10 determines that the inference of the commodity is correct, and therefore makes a definitive decision on the commodity (Step S207). Further, when the commodity is not a non-payment article (No in Step S208), the inference unit 12 supplies commodity information of the inferred commodity to the payment unit 17 (Step S209). When the commodity is a non-payment article (Yes in Step S208), the inference unit 12 deletes the commodity information of the non-payment article (Step S210).

Lastly, the payment unit 17 carries out a payment for the commodity based on the commodity information supplied by the inference unit 12 (Step S211).

Therefore, in the commodity recognition system 2 according to the second example embodiment, similarly to the commodity recognition system 1, it is possible to reduce the possibility that a payment is carried out without recognizing mis-recognition of a commodity. Further, in the commodity recognition system 2, it is possible, by visually emphasizing a non-payment article, such as displaying a non-payment article in a shaded manner, to reduce the possibility that a user overlooks, i.e., fails to notice, mis-recognition of a commodity in the commodity recognition system 2.

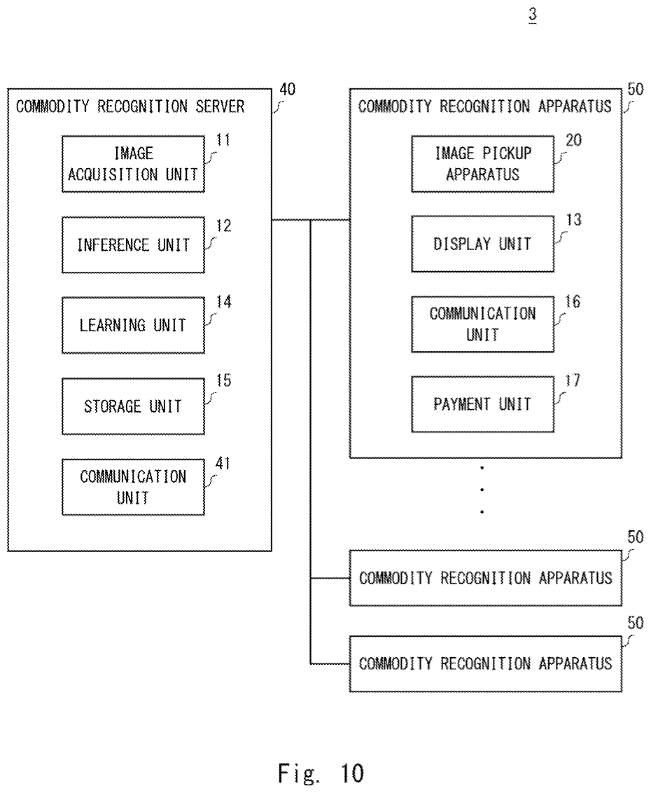

Next, a configuration of a commodity recognition system 3 according to a third example embodiment will be described with reference to FIG. 10. As shown in FIG. 10, the commodity recognition system 3 includes a commodity recognition server 40 and at least one commodity recognition apparatus 50. Note that the commodity recognition server 40 performs some of the processes performed by the commodity recognition apparatus 10 according to the second example embodiment on behalf of the commodity recognition apparatus 10.

The commodity recognition server 40 includes the image acquisition unit 11, the inference unit 12, the learning unit 14, and the storage unit 15 of the commodity recognition apparatus 10 according to the second example embodiment. Further, the commodity recognition server 40 includes a communication unit 41, and the communication unit 41 communicates with each of the commodity recognition apparatuses 50 wirelessly or through a cable.

Each of the commodity recognition apparatuses 50 includes the image pickup apparatus 20, and the display unit 13, the communication unit 16, and the payment unit 17 of the commodity recognition apparatus 10 according to the second example embodiment. Further, the communication unit 16 of the commodity recognition apparatus 50 communicates with the commodity recognition server 40 wirelessly or through a cable.

Note that some of the processes which are performed by the commodity recognition apparatus 10 in the second example embodiment, but are performed by the commodity recognition server 40 on behalf of the commodity recognition apparatus 10 in this example embodiment are not limited to the aforementioned functions.

For example, the commodity recognition system 3 according to the third example embodiment performs operations described below.

Firstly, the image pickup apparatus 20 of the commodity recognition apparatus 50 takes an image of commodities including a payment article(s) when a user makes a payment. Next, the image acquisition unit 11 of the commodity recognition server 40 acquires the taken image from the commodity recognition apparatus 50. Next, the inference unit 12 of the commodity recognition server 40 identifies a commodity included in the image, and infers whether the identified article is a payment article or a non-payment article by referring to identification information of commodities and information indicating whether the commodities are payment articles or not, both of which are associated with each other and stored in advance. Then, the inference unit 12 transmits the inferred information to the commodity recognition apparatus 50. Next, the display unit 13 of the commodity recognition apparatus 50 displays the payment article(s) and the non-payment article(s) for the user while distinguishing them from each other

Therefore, the commodity recognition system 3 according to the third example embodiment provides advantageous effects similar to those of the commodity recognition system 2. Further, in the commodity recognition system 3, it is possible to collectively perform, in the commodity recognition server 40, the processes that are performed by the commodity recognition apparatus 10 of the commodity recognition system 2 in the second example embodiment.

Note that the present disclosure is not limited to the above-described example embodiments and various modifications can be made within the scope and spirit of the disclosure.

### Hardware Configuration

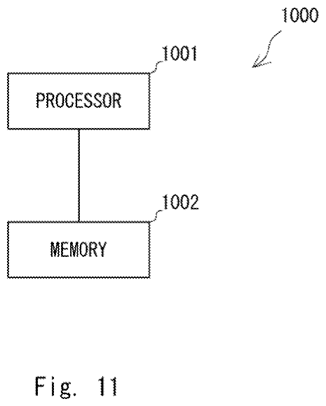

Next, an example of a hardware configuration of a computer 1000 for the commodity recognition apparatus 10, the image pickup apparatus 20, the commodity recognition server 40, and the commodity recognition apparatus 50 will be described with reference to FIG. 11. In FIG. 11, the computer 1000 includes a processor 1001 and a memory 1002. The processor 1001 may be, for example, a microprocessor, a MPU (Micro Processing Unit), or a CPU (Central Processing Unit). The processor 1001 may include a plurality of processors. The memory 1002 is formed by a combination of a volatile memory and a non-volatile memory. The memory 1002 may include a storage disposed remotely from the processor 1001. In this case, the processor 1001 may access the memory 1002 through an I/O interface (not shown).

Further, each of the apparatuses in the above-described example embodiments may be formed by software, hardware, or both of them. Further, each of the apparatuses may be formed by one hardware device or one software program, or a plurality of hardware devices or a plurality of software programs. The function (the process) of each of the apparatuses in the above-described example embodiments may be implemented by a computer. For example, a program for causing a computer to perform a method according to an example embodiment may be stored in the memory 1002, and each function may be implemented by having the processor 1001 execute the program stored in the memory 1002.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

According to the present disclosure, it is possible to provide a commodity recognition system, a method, and a non-transitory computer readable medium capable of reducing a possibility that a payment is carried out without recognizing mis-recognition of a commodity.

While the invention has been particularly shown and described with reference to embodiments thereof, the invention is not limited to these embodiments. It will be understood by those of ordinary skill in the art that various changes in form and details may be made therein without departing from the spirit and scope of the present invention as defined by the claims.

What is claimed is:

1. A commodity recognition system comprising:
an image acquisition unit configured to acquire an image of an article including a payment article when a user makes a payment;
an inference unit configured to identify the article included in the image, and infer whether the identified article is the payment article or a non-payment article by referring to identification information of an article and information indicating whether the article is the payment article or not, the identification information and the information indicating whether the article is the payment article or not being associated with each other and stored in advance; and
a display unit configured to display the payment article and the non-payment article for the user while distinguishing them from each other.

2. The commodity recognition system according to claim 1, wherein the display unit displays a window including the payment article and the non-payment article, and distinguishes the payment article and the non-payment article from each other by displaying the non-payment article in a more emphasized manner than the payment article.

3. The commodity recognition system according to claim 2, wherein the display unit displays a window including the payment article and the non-payment article, and distinguishes the payment article and the non-payment article from each other by displaying an area corresponding the non-payment article in a shaded manner in the displayed window.

4. The commodity recognition system according to claim 1, wherein the inference unit identifies an article included in the image by using an outer shape of the article as a feature value.

5. The commodity recognition system according to claim 1, wherein the payment article is an article that is provided to the user for a fee, and the non-payment article is an article that is provided to the user free of charge.

6. A method comprising:
acquiring an image of an article including a payment article when a user makes a payment;
identifying the article included in the image, and infer whether the identified article is the payment article or a non-payment article by referring to identification information of an article and information indicating whether the article is the payment article or not, the identification information and the information indicating whether the article is the payment article or not being associated with each other and stored in advance; and
displaying the payment article and the non-payment article for the user while distinguishing them from each other.

7. A non-transitory computer readable medium storing a program for causing a computer to perform:
a process for acquiring an image of an article including a payment article when a user makes a payment;
a process for identifying the article included in the image, and infer whether the identified article is the payment article or a non-payment article by referring to identification information of an article and information indicating whether the article is the payment article or not, the identification information and the information indicating whether the article is the payment article or not being associated with each other and stored in advance; and
a process for displaying the payment article and the non-payment article for the user while distinguishing them from each other.
